(19) United States
(12) Patent Application Publication
(10) Pub. No.: US 2008/0037620 A1
(43) Pub. Date: Feb. 14, 2008

(54) METHOD AND APPARATUS FOR ESTIMATING A NOISE POWER FOR OFDM

(75) Inventors: Afshin Haghighat, Ile-Bizard (CA); Seyed M. Hosseinian, E. Northport, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 11/835,093

(22) Filed: Aug. 7, 2007

Related U.S. Application Data
(60) Provisional application No. 60/837,024, filed on Aug. 11, 2006.

(51) Int. Cl. H04B 3/46; H04B 17/00

(52) U.S. Cl. 375/227

(57) ABSTRACT

A method and apparatus for estimating noise for orthogonal frequency division multiplexing (OFDM) are disclosed. A time domain difference signal and a frequency domain difference signal between two consecutive received pilot symbols are calculated. A time domain noise power is calculated from the time domain difference signal and a frequency domain noise power is calculated from the frequency domain difference signal. The time domain noise power and the frequency domain noise power are combined to estimate the noise power.

### CROSS REFERENCE TO RELATED APPLICATION

This application claims the benefit of U.S. provisional Application No. 60/837,024, filed on Aug. 11, 2006, which is incorporated by reference as if fully set forth.

### FIELD OF INVENTION

The present invention is related to wireless communication system. More particularly, the present invention is related to a method and apparatus for estimating noise for orthogonal frequency division multiplexing (OFDM).

### BACKGROUND

Orthogonal frequency division multiplexing (OFDM) is a data transmission schemes, where the data is split into smaller streams and each stream is transmitted using a sub-carrier with a smaller bandwidth than the total available transmission bandwidth. The efficiency of OFDM is a result of the fact that the sub-carriers are selected so that they are orthogonal to each other. In other words, the sub-carriers do not interfere with each other while each is carrying a portion of the total user data.

There are practical reasons why OFDM may be preferred over other transmission schemes such as Code Division Multiple Access (CDMA). When the user data is split into streams carried by different sub-carriers, the effective data rate on each sub-carrier is less than the total data rate. Therefore, the symbol duration is much larger. Large symbol duration can tolerate larger delay spreads. In other words, data that is transmitted with a large symbol duration is not affected by multipath as severely as symbols with a shorter duration. OFDM symbols can tolerate delay spreads that are typical in wireless communications and do not require complicated receiver designs to recover from multipath delay.

As in nearly any communication system, however, a wireless communication system is subject to noise and interference which can distort the signal and corrupt the reception of the transmitted data. Accordingly, methods and devices for dealing with noise and interference have been employed. Some of these methods, or techniques, attempt to estimate the noise power in order to eliminate it from the received signal.

Conventional techniques for noise power estimation have some limitations. Some of these limitations include requiring preamble reference signals, relying on channel estimation, having high complexity for implementation or performing only snap-shot measurements with no tracking.

Therefore, it is desirable to provide a noise power estimation method which is independent of channel estimation, has low complexity and tracking capability, and is applicable in both single-input single-output (SISO) and multiple-input multiple-output (MIMO) OFDM applications.

### SUMMARY

The present invention comprises a method and apparatus for estimating noise for OFDM systems. A time domain difference signal and a frequency domain difference signal between two consecutive received pilot symbols are calculated. A time domain noise power is calculated from the time domain difference signal and a frequency domain noise power is calculated from the frequency domain difference signal. The time domain noise power and the frequency domain noise power are combined to estimate the overall noise power.

### BRIEF DESCRIPTION OF THE DRAWINGS

FIG. 1 is a functional block diagram of a Wireless Transmit Receive Unit in accordance with the present invention.

FIG. 2 illustrates noise estimation in both time and frequency domains.

FIG. 3 illustrates simple channel estimation using adjacent samples.

FIG. 4 is a flow diagram of a method of noise estimation in accordance with a preferred embodiment of the present invention.

### DETAILED DESCRIPTION OF THE PREFERRED EMBODIMENTS

The present invention is applicable to a wireless transmit/receive unit (WTRU) and a base station. The terminology “WTRU” includes but is not limited to a user equipment, a mobile station, a fixed or mobile subscriber unit, a pager, or any other type of device capable of operating in a wireless environment. The terminology “base station” includes but is not limited to a Node-B, a site controller, an access point or any other type of interfacing device in a wireless environment.

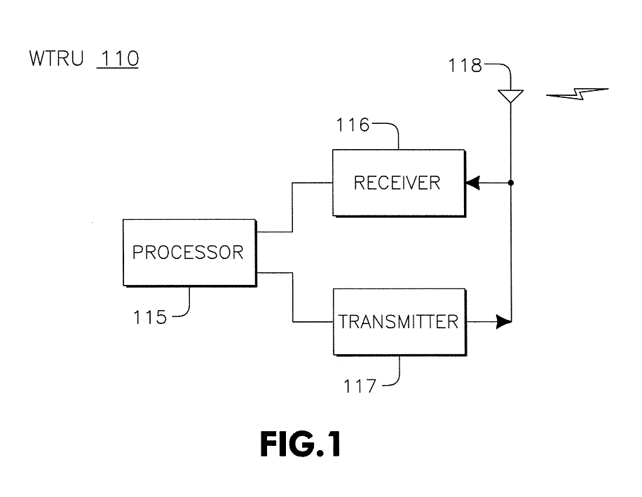

FIG. 1 is a functional block diagram of a WTRU 110 configured to perform a method of noise estimation in accordance with the present invention. In addition to components included in a typical WTRU, WTRU 110 includes a processor 115 configured to perform a method of noise power estimation in accordance with the present invention, a receiver 116 in communication with processor 115, a transmitter 117 in communication with processor 115, and an antenna 118 in communication with receiver 116 and transmitter 117, to facilitate the transmission and reception of wireless data. For purposes of a preferred embodiment of the present invention, wireless data transmitted and received over an orthogonal frequency division multiplexing wireless communication system. Additionally, the receiver 116, transmitter 117 and antenna 118 may be a single receiver, transmitter and antenna, or may include a plurality of individual receivers, transmitters and antennas, respectively.

The system, method and apparatus of the present invention disclosed herein comprises noise power estimation which uses pilot signals in the frequency domain. The estimated noise power is then used for channel estimation and data detection. In accordance with a preferred embodiment of the present invention, the noise power of the received signal is estimated without relying on an accurate channel estimate.

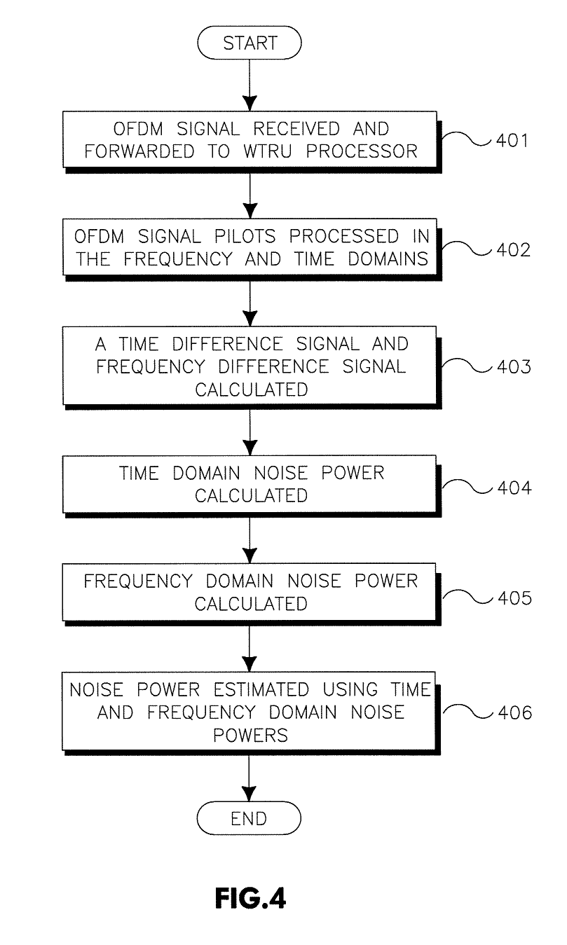

FIG. 4 is a flow diagram of a preferred method of noise estimation used by WTRU 110. In the method according to a preferred embodiment, WRTU 110 receives an OFDM signal through antenna 118 and receiver 116. The received OFDM signal is then forwarded to processor 115 (step 401), which processes the pilot signal in the received signal in both time and frequency domains (step 402). A time domain difference signal and a frequency domain difference signal between two consecutive received pilot symbols are calculated by processor (step 403). A time domain noise power is calculated from the time domain difference signal (step 404) and a frequency domain noise power is calculated from the frequency domain difference signal (step 405). The time domain noise power and the frequency domain noise power are then combined to estimate the noise power (step 406). It should be noted that the processing of the pilot signals in the frequency and time domains may be conducted in any order, e.g., the frequency domain noise power may be calculated prior to the time domain noise power.

With respect to processing of the pilot signals in the frequency domain, the received OFDM signal is preferably processed as follows. A received sampled OFDM signal, after removing the cyclic prefix and performing discrete Fourier transform (DFT), is written as follows:

yₖ[n]=xₖ[n]hₖ[n]+zₖ[n]; Equation (1)

where n is an index of samples, xₖ[n] is a transmitted symbol, hₖ[n] is a frequency domain channel response and zₖ[n] is an additive white Gaussian noise (AWGN) noise for the kₜₕ subcarrier, respectively. Assuming the processed OFDM signal is a pilot (or a reference signal) with a complex known amplitude aₖ[n], the received sample OFDM signal is written as follows:

yₖ[n]=aₖ[n]hₖ[n]+zₖ[n]. Equation (2)

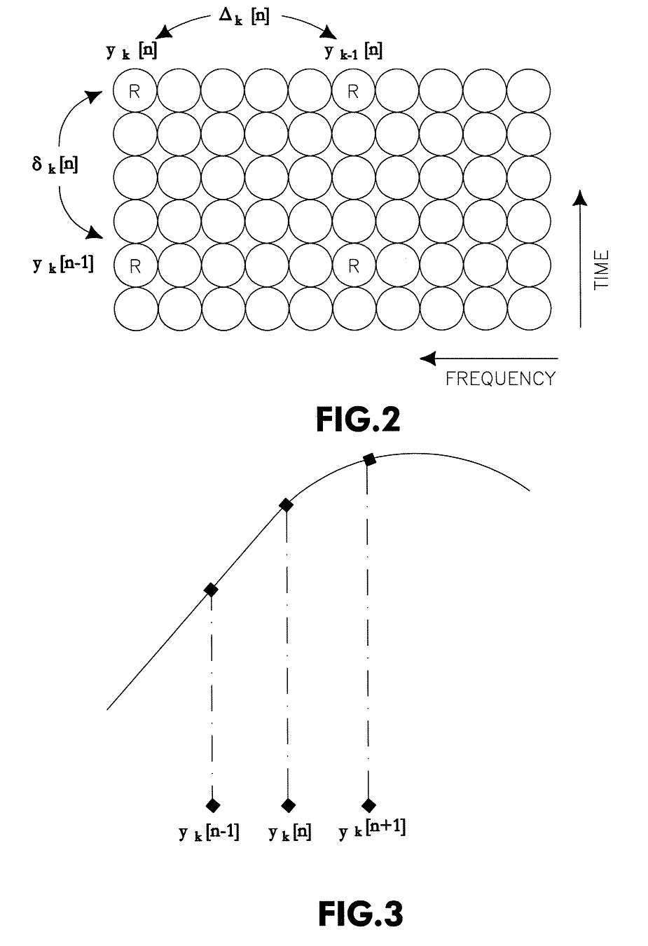

FIG. 2 shows noise estimation in both time and frequency domains. As shown in FIG. 2, based on the available reference pilots, processor 115 defines two difference signals in the time and frequency domains as:

Time domain difference signal:

$$\begin{matrix}{δ}_{k} [ n ] = {y}_{k} [ n ] - {y}_{k} [ n - 1 ] \\ = ( {a}_{k} [ n ] {h}_{k} [ n ] - {a}_{k} [ n - 1 ] {h}_{k} [ n - 1 ] ) + \\ ( {z}_{k} [ n ] - {z}_{k} [ n - 1 ] ) ; and\end{matrix} \qquad Equation ( 3 )$$

Frequency domain difference signal:

$$\begin{matrix}{Δ}_{k} [ n ] = {y}_{k} [ n ] - {y}_{k - 1} [ n ] \\ = ( {a}_{k} [ n ] {h}_{k} [ n ] - {a}_{k - 1} [ n ] {h}_{k - 1} [ n ] ) + \\ ( {z}_{k - 1} [ n ] - {z}_{k - 1} [ n ] ) .\end{matrix} \qquad Equation ( 4 )$$

With respect to the time domain, the second order average of the time domain difference signal is evaluated as:

$${E}_{t} \{ {δ}_{k} [ n ] {δ}_{k}^{*} [ n ] \} = {E}_{t} \{ \begin{matrix}( {a}_{k} [ n ] {h}_{k} [ n ] - {a}_{k} [ n - 1 ] {h}_{k} [ n - 1 ] ) \\ {( {a}_{k} [ n ] {h}_{k} [ n ] - {a}_{k} [ n - 1 ] {h}_{k} [ n - 1 ] )}^{*}\end{matrix} \} + {E}_{t} \{ \begin{matrix}( {a}_{k} [ n ] {h}_{k} [ n ] - {a}_{k} [ n - 1 ] {h}_{k} [ n - 1 ] ) \\ {( {z}_{k} [ n ] - {z}_{k} [ n - 1 ] )}^{*}\end{matrix} \} + {E}_{t} \{ \begin{matrix}{( {a}_{k} [ n ] {h}_{k} [ n ] - {a}_{k} [ n - 1 ] {h}_{k} [ n - 1 ] )}^{*} \\ ( {z}_{k} [ n ] - {z}_{k} [ n - 1 ] )\end{matrix} \} + {E}_{t} \{ ( {z}_{k} [ n ] - {z}_{k} [ n - 1 ] ) {( {z}_{k} [ n ] - {z}_{k} [ n - 1 ] )}^{*} \} . \qquad Equation ( 5 )$$

Since the signal and noise terms are independent,

$${E}_{t} \{ {δ}_{k} [ n ] {δ}_{k}^{*} [ n ] \} = {\vert {a}_{k} [ n ] \vert}^{2} {E}_{t} \{ {\vert {h}_{k} [ n ] \vert}^{2} \} + {\vert {a}_{k} [ n - 1 ] \vert}^{2} {E}_{t} \{ {\vert {h}_{k} [ n - 1 ] \vert}^{2} \} - {a}_{k} [ n ] {a}_{k}^{*} [ n - 1 ] E \{ {h}_{k} [ n ] {h}_{k}^{*} [ n - 1 ] \} - {a}_{k}^{*} [ n ] {a}_{k} [ n - 1 ] E \{ {h}_{k}^{*} [ n ] {h}_{k} [ n - 1 ] \} + 2 {σ}_{{N}_{t}}^{2} ; \qquad Equation ( 6 )$$

where σ_{Nt}² is the noise power measured over time.

An estimate of the noise power in time domain is then computed as follows:

$${σ}_{{N}_{t}}^{2} = \frac{1}{2} {E}_{t} \{ {δ}_{k} [ n ] {δ}_{k}^{*} [ n ] \} - \frac{{\vert {a}_{k} [ n ] \vert}^{2}}{2} {E}_{t} \{ {\vert {h}_{k} [ n ] \vert}^{2} \} - \frac{{\vert {a}_{k} [ n - 1 ] \vert}^{2}}{2} {E}_{t} \{ {\vert {h}_{k} [ n - 1 ] \vert}^{2} \} + \frac{{a}_{k} [ n ] {a}_{k}^{*} [ n - 1 ]}{2} E \{ {h}_{k} [ n ] {h}_{k}^{*} [ n - 1 ] \} + \frac{{a}_{k}^{*} [ n ] {a}_{k} [ n - 1 ]}{2} E \{ {h}_{k}^{*} [ n ] {h}_{k} [ n - 1 ] \} . \qquad Equation ( 7 )$$

To evaluate the noise estimation expressed in Equation (7), estimates of the channel are required. Using pilot subcarriers, a simple estimate of the channel is obtained as follows:

$${\hat{h}}_{k} [ n ] = \frac{1}{{\vert {a}_{k} \vert}^{2}} {a}_{k}^{*} [ n ] {y}_{k} [ n ] = {h}_{k} [ n ] + \frac{{a}_{k}^{*} [ n ]}{{\vert {a}_{k} [ n ] \vert}^{2}} {z}_{k} [ n ] . \qquad Equation ( 8 )$$

In a fixed channel, the accuracy of such an estimate may be improved by averaging over long period of time. However, in a fast time-varying fading channel, the number of samples should be kept as low as possible. Therefore, for a time-varying channel, the instantaneous channel estimate may be further refined by processing the current estimate and its adjacent estimates as shown in FIG. 3. A number of interpolation methods can be employed to provide such estimates. The preferred form of interpolation is to perform averaging of the current estimate and its adjacent estimate. FIG. 3 shows a channel estimate using adjacent samples.

Therefore, the channel estimation for the n-th sample required for evaluation of Equation (7) may be derived as follows:

$$\begin{matrix}{\hat{h}}_{k} [ n ] = \frac{1}{3 {\vert {a}_{k} \vert}^{2}} {a}_{k}^{*} [ n ] \{ {y}_{k} [ n - 1 ] + {y}_{k} [ n ] + {y}_{k} [ n + 1 ] \} \\ = \frac{1}{3} \{ {h}_{k} [ n - 1 ] + {h}_{k} [ n ] + {h}_{k} [ n + 1 ] \} + \\ \frac{{a}_{k}^{*} [ n ]}{3 {\vert {a}_{k} [ n ] \vert}^{2}} \{ {z}_{k} [ n - 1 ] + {z}_{k} [ n ] + {z}_{k} [ n + 1 ] \} .\end{matrix} \qquad Equation ( 9 )$$

Similarly, the channel estimate for the (n-1)th sample required for evaluation of Equation (7) may be derived as follows:

$${\hat{h}}_{k} [ n - 1 ] = \frac{1}{3} \{ {h}_{k} [ n - 2 ] + {h}_{k} [ n - 1 ] + {h}_{k} [ n ] \} + \frac{{a}_{k}^{*} [ n ]}{3 {\vert {a}_{k} [ n ] \vert}^{2}} 0 \{ {z}_{k} [ n - 2 ] + {z}_{k} [ n - 1 ] + {z}_{k} [ n ] \} . \qquad Equation ( 10 )$$

With respect to the frequency domain, using Equation (4), a similar approach for noise power estimation in the frequency domain is developed using pilot subcarriers across the frequency band.

$${E}_{f} \{ {Δ}_{k} [ n ] {Δ}_{k}^{*} [ n ] \} = {\vert {a}_{k} [ n ] \vert}^{2} {E}_{f} \{ {\vert {h}_{k} [ n ] \vert}^{2} \} + {\vert {a}_{k - 1} [ n ] \vert}^{2} {E}_{f} \{ {\vert {h}_{k - 1} [ n ] \vert}^{2} \} - {a}_{k} [ n ] {a}_{k - 1}^{*} [ n ] {E}_{f} \{ {h}_{k} [ n ] {h}_{k - 1}^{*} [ n ] \} - {a}_{k}^{*} [ n ] {a}_{k - 1} [ n ] {E}_{f} \{ {h}_{k}^{*} [ n ] {h}_{k - 1} [ n ] \} + 2 {σ}_{N}^{2} ; \qquad Equation ( 11 )$$

where σ_{Nf}² is the noise power measured over the frequency.

Then, for frequency correlated and uncorrelated channels, the noise estimation in the frequency domain is evaluated as:

$${σ}_{{N}_{f}}^{2} = \frac{1}{2} {E}_{f} \{ {Δ}_{k} [ n ] {Δ}_{k}^{*} [ n ] \} - \frac{{\vert {a}_{k} [ n ] \vert}^{2}}{2} {E}_{f} \{ {\vert {h}_{k} [ n ] \vert}^{2} \} - \frac{{\vert {a}_{k - 1} [ n ] \vert}^{2}}{2} {E}_{f} \{ {\vert {h}_{k} [ n ] \vert}^{2} \} + \frac{{a}_{k} [ n ] {a}_{k - 1}^{*} [ n ]}{2} {E}_{f} \{ {h}_{k} [ n ] {h}_{k - 1}^{*} [ n ] \} + \frac{{a}_{k}^{*} [ n ] {a}_{k - 1} [ n ]}{2} {E}_{f} \{ {h}_{k}^{*} [ n ] {h}_{k - 1} [ n ] \} . \qquad Equation ( 12 )$$

Similarly, the channel estimates for the k-th subcarrier required for evaluation of Equation (12) may be derived as:

$${\hat{h}}_{k} [ n ] = \frac{1}{3} \{ {h}_{k - 1} [ n ] + {h}_{k} [ n ] + {h}_{k + 1} [ n ] \} + \frac{{a}_{k}^{*} [ n ]}{3 {\vert {a}_{k} [ n ] \vert}^{2}} \{ {z}_{k - 1} [ n ] + {z}_{k} [ n ] + {z}_{k + 1} [ n ] \} . \qquad Equation ( 13 )$$

Similarly, the channel estimates for the (k-1)th subcarrier required for evaluation of Equation (12) may be derived as:

$${\hat{h}}_{k - 1} [ n ] = \frac{1}{3} \{ {h}_{k - 2} [ n ] + {h}_{k - 1} [ n ] + {h}_{k} [ n ] \} + \frac{{a}_{k}^{*} [ n ]}{3 {\vert {a}_{k} [ n ] \vert}^{2}} \{ {z}_{k - 2} [ n ] + {z}_{k - 1} [ n ] + {z}_{k} [ n ] \} . \qquad Equation ( 14 )$$

Using the estimated noise power in the time and frequency domains, the overall noise power estimate is evaluated by linearly combining the two noise estimates available from processing of the pilots in the time and frequency domains as follows:

σ_{N}²=ασ_{Nt}²+βσ_{Nf}²; Equation (15)

where α and β are proper combining factors for a given system.

The main advantages of the present invention are independence from accurate channel estimation, low complexity, tracking capability, and applicability in both Single In Single Out and Multiple In Multiple Out OFDM applications.

Although the features and elements of the present invention are described in the preferred embodiments in particular combinations, each feature or element can be used alone without the other features and elements of the preferred embodiments or in various combinations with or without other features and elements of the present invention. The methods or flow charts provided in the present invention may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. A method for estimating noise power in an orthogonal frequency division multiplexing (OFDM) wireless communication system, the method comprising:
calculating a time domain difference signal and a frequency domain difference signal between two consecutive received symbols in said OFDM signal;
calculating a time domain noise power;
calculating a frequency domain noise power; and
combining the time domain noise power and the frequency domain noise power to estimate the noise power.

2. The method of claim 1, wherein the received symbols are pilot symbols.

3. The method of claim 2, wherein the time domain noise power and the frequency domain noise power are derived based on a channel estimate.

4. The method of claim 3, wherein said time domain noise power is estimated in accordance with the equation:
$${σ}_{{N}_{t}}^{2} = \frac{1}{2} {E}_{t} \{ {δ}_{k} [ n ] {δ}_{k}^{*} [ n ] \} - \frac{{\vert {a}_{k} [ n ] \vert}^{2}}{2} {E}_{t} \{ {\vert {h}_{k} [ n ] \vert}^{2} \} - \frac{{\vert {a}_{k} [ n - 1 ] \vert}^{2}}{2} {E}_{t} \{ {\vert {h}_{k} [ n - 1 ] \vert}^{2} \} + \frac{{a}_{k} [ n ] {a}_{k}^{*} [ n - 1 ]}{2} E \{ {h}_{k} [ n ] {h}_{k}^{*} [ n - 1 ] \} + \frac{{a}_{k}^{*} [ n ] {a}_{k} [ n - 1 ]}{2} E \{ {h}_{k}^{*} [ n ] {h}_{k} [ n - 1 ] \} .$$

5. The method of claim 4, wherein said channel estimate for said time domain noise power is estimated in accordance with the equation:
$${\hat{h}}_{k} [ n ] = \frac{1}{{\vert {a}_{k} \vert}^{2}} {a}_{k}^{*} [ n ] {y}_{k} [ n ] = {h}_{k} [ n ] + \frac{{a}_{k}^{*} [ n ]}{{\vert {a}_{k} [ n ] \vert}^{2}} {z}_{k} [ n ] .$$

6. The method of claim 3, wherein said frequency domain noise power is estimated in accordance with the equation:
$${σ}_{{N}_{f}}^{2} = \frac{1}{2} {E}_{f} \{ {Δ}_{k} [ n ] {Δ}_{k}^{*} [ n ] \} - \frac{{\vert {a}_{k} [ n ] \vert}^{2}}{2} {E}_{f} \{ {\vert {h}_{k} [ n ] \vert}^{2} \} - \frac{{\vert {a}_{k - 1} [ n ] \vert}^{2}}{2} {E}_{f} \{ {\vert {h}_{k} [ n ] \vert}^{2} \} + \frac{{a}_{k} [ n ] {a}_{k - 1}^{*} [ n ]}{2} {E}_{f} \{ {h}_{k} [ n ] {h}_{k - 1}^{*} [ n ] \} + \frac{{a}_{k}^{*} [ n ] {a}_{k - 1} [ n ]}{2} {E}_{f} \{ {h}_{k}^{*} [ n ] {h}_{k - 1} [ n ] \} .$$

7. The method of claim 6, wherein said channel estimate for said frequency domain noise power is estimated in accordance with the equation:
$${\hat{h}}_{k} [ n ] = \frac{1}{3} \{ {h}_{k - 1} [ n ] + {h}_{k} [ n ] + {h}_{k + 1} [ n ] \} + \frac{{a}_{k}^{*} [ n ]}{3 {\vert {a}_{k} [ n ] \vert}^{2}} \{ {z}_{k - 1} [ n ] + {z}_{k} [ n ] + {z}_{k + 1} [ n ] \} .$$

8. The method of claim 1, wherein the time domain noise power and the frequency domain noise power are linearly combined.

9. The method of claim 1, wherein said combination is estimated in accordance with the equation:
σ_{N}²=ασ_{Nt}²+βσ_{Nf}²;
wherein α and β are proper combining factors for a given system.

10. The method of claim 1, wherein the OFDM system is a single-input single-output (SISO) system.

11. The method of claim 1, wherein the OFDM system is a multiple-input multiple-output (MIMO) system.

12. A Wireless Transmit Receive Unit (WTRU) for communicating in an orthogonal frequency division multiplexing (OFDM) wireless communication system, the WTRU comprising:
a receiver for receiving OFDM signals; and
a processor, coupled to the receiver, for estimating a noise power;
wherein said processor is configured to:
calculate a time domain difference signal and a frequency domain difference signal between two consecutive received symbols in said OFDM signal;
calculate time domain and frequency domain noise powers; and
combine the time domain noise power and the frequency domain noise power.

13. The WTRU of claim 12, wherein the received symbols are pilot symbols.

14. The WTRU of claim 13, wherein the time domain noise power and the frequency domain noise power are derived based on a channel estimate said channel estimate.

15. The WTRU of claim 14, wherein said time domain noise power is estimated in accordance with the equation:
$${σ}_{{N}_{t}}^{2} = \frac{1}{2} {E}_{t} \{ {δ}_{k} [ n ] {δ}_{k}^{*} [ n ] \} - \frac{{\vert {a}_{k} [ n ] \vert}^{2}}{2} {E}_{t} \{ {\vert {h}_{k} [ n ] \vert}^{2} \} - \frac{{\vert {a}_{k} [ n - 1 ] \vert}^{2}}{2} {E}_{t} \{ {\vert {h}_{k} [ n - 1 ] \vert}^{2} \} + \frac{{a}_{k} [ n ] {a}_{k}^{*} [ n - 1 ]}{2} E \{ {h}_{k} [ n ] {h}_{k}^{*} [ n - 1 ] \} + \frac{{a}_{k}^{*} [ n ] {a}_{k} [ n - 1 ]}{2} E \{ {h}_{k}^{*} [ n ] {h}_{k} [ n - 1 ] \} .$$

16. The WTRU of claim 15, wherein said channel estimate for said time domain noise power is estimated in accordance with the equation:
$${\hat{h}}_{k} [ n ] = \frac{1}{{\vert {a}_{k} \vert}^{2}} {a}_{k}^{*} [ n ] {y}_{k} [ n ] = {h}_{k} [ n ] + \frac{{a}_{k}^{*} [ n ]}{{\vert {a}_{k} [ n ] \vert}^{2}} {z}_{k} [ n ] .$$

17. The WTRU of claim 16, wherein said frequency domain noise power is estimated in accordance with the equation:
$${σ}_{{N}_{f}}^{2} = \frac{1}{2} {E}_{f} \{ {Δ}_{k} [ n ] {Δ}_{k}^{*} [ n ] \} - \frac{{\vert {a}_{k} [ n ] \vert}^{2}}{2} {E}_{f} \{ {\vert {h}_{k} [ n ] \vert}^{2} \} - \frac{{\vert {a}_{k - 1} [ n ] \vert}^{2}}{2} {E}_{f} \{ {\vert {h}_{k} [ n ] \vert}^{2} \} + \frac{{a}_{k} [ n ] {a}_{k - 1}^{*} [ n ]}{2} {E}_{f} \{ {h}_{k} [ n ] {h}_{k - 1}^{*} [ n ] \} + \frac{{a}_{k}^{*} [ n ] {a}_{k - 1} [ n ]}{2} {E}_{f} \{ {h}_{k}^{*} [ n ] {h}_{k - 1} [ n ] \} .$$

18. The WTRU of claim 17, wherein said channel estimate for said frequency domain noise power is estimated in accordance with the equation:
$${\hat{h}}_{k} [ n ] = \frac{1}{3} \{ {h}_{k - 1} [ n ] + {h}_{k} [ n ] + {h}_{k + 1} [ n ] \} + \frac{{a}_{k}^{*} [ n ]}{3 {\vert {a}_{k} [ n ] \vert}^{2}} \{ {z}_{k - 1} [ n ] + {z}_{k} [ n ] + {z}_{k + 1} [ n ] \} .$$

19. The WTRU of claim 18, wherein the time domain noise power and the frequency domain noise power are linearly combined.

20. The WTRU of claim 19, wherein said combination is estimated in accordance with the equation:
σ_{N}²=ασ_{Nt}²+βσ_{Nf}²;
wherein α and β are proper combining factors for a given system.

21. The WTRU of claim 12, wherein the OFDM system is a single-input single-output (SISO) system.

22. The WTRU of claim 12, wherein the OFDM system is a multiple-input multiple-output (MIMO) system.
